(19) United States
(12) Patent Application Publication
(10) Pub. No.: US 2005/0017110 A1
(43) Pub. Date: Jan. 27, 2005

(54) Vertical shaft impactor with suspended impeller

(76) Inventors: Louis Wein Johnson, Eugene, OR (US); Bruce G. Johnson, Monroe, OR (US)

Correspondence Address: LOUIS W. JOHNSON, 345 PALOMINO DRIVE, EUGENE, OR, 97401, US

(21) Appl. No.: 10/623,942

(22) Filed: Jul. 22, 2003

(51) Int. Cl. B02C 19/00

(52) U.S. Cl. 241/275

(57) ABSTRACT

A vertical shaft impact crusher having a suspended impeller attachable to a hollow spindle with a modified gun lock system secured in place by fixed stops and sliding stops cam operated and clamped by a gear rotated nut. Said spindle journalled in a single ball bearing contained in a housing supported on flexible means; lubricant force jetted into said bearing from a pump initially driven by a small motor followed by being driven by one of two motors driving said spindle to insure against loss of lubricant by power failure to small motor. A frame supported by four vertical columns; a second smaller frame within said columns and connected to elevating means to raise and lower said smaller frame; self latching means to hold said smaller frame at its upper elevated position; camming means to release self latching means. An annular chamber centered on said smaller frame and attached to frame by bolts is partially covered over on its top; its uncovered portion is sealed against a member supporting a complete bearing-spindle assembly; The underside of said annular chamber has a center opening to discharge crushed product into a conical hopper having a telescoping extension. Two opposed motors each suspended below swingable frames drive said spindle with multiple vee belts; an inverted cup shaped vee sheave is attached to the top face of said spindle; it has the same number of vee grooves above and below a plane through the rolling elements of said ball bearing; motor sheaves positioned to drive an equal number of belts above and below said plane with balanced pulling forces. Said motor bases push-pulled by power means with pushing mode having belt tension control. A hopper above said spindle has a static tube depending through said hollow spindle and into said impeller a designed distance and bypass means spaced apart farther than the diameter of said impeller.

### BACKGROUND OF THE INVENTION

Next to food, clothing, and shelter, rock in useable form is the most important product of advanced society. It is essential for building homes, roads, buildings, dams, airports railroads, and other uses for human benefits. Rock in gravel form where deposited is less costly to process than quarry rock, but in either form it rarely can it be used as found, consequently it must be reduced to required sizes; in some third world countries rock is manually crushed with hammers where one person might produce a ton of rock per day of rock in sizes mostly too large for best usage. In modern societies rock is crushed in enormous volumes by machinery and few workers. Rock crushers are normally used in three or more sequential stages: First a compression type primaries either jaw or gyratory for large size rock, second stage usually gyrating cone type for reducing oversize rock from the first stage to the larger useable sizes, and tertiary stage for the smallest but very essential sizes. It is very difficult to produce fine crushed rock with compression type crushers; the stresses are very high and volume is low and the wear rate of wear liners is costly.

Since the mid twentieth century a form of crusher called a “VSI” in the trade, an acronym for Vertical Shaft Impactor, was invented; it uses a high speed impeller mounted on the top end of a vertical shaft. It throws the rock against metal anvils. Many different manufacturers have brought this concept to market, but the extremely high costs of maintenance both in parts and frequent need of labor to change impeller slingers and anvils has been a bane to their success. There is another design of VSI that crushes rock on rock which eliminates anvils and their high costs, but it has less crushing efficiency and higher power demand per ton of net product; it uses essentially the same mechanics as does the anvil design except the rock chamber. Our design in this patent application is a new concept of the mechanics of rock on rock crushing; it is substantially easier and faster to service and reduces the costs of fine crushing to be very acceptable.

### BRIEF SUMMARY OF THE INVENTION

A Vertical Shaft Impact crusher having a rectangular frame supported above four upright parallel columns and braced for rigid construction. A rectangular plate means midway to the length of said frame and supporting a hollow spindle suspended by a single antifriction bearing contained within an annular enclosure having sealing means to exclude contaminates and retain lubricants; said enclosure supported by flexible means to absorb harmful vibration and unbalancing forces. An inverted cup shaped vee belt sheave attached to the top end of said hollow spindle and having an equal number of vee grooves above and below the radial centerline of said bearing. At the lower end of said spindle a modified gunlock connection between spindle and an impeller; said impeller having two or more ports to eject propelled rock or ore at high velocities to collide with other rock or ore and cause breakage of same. A static tube within said spindle to conduct rock or ore into said impeller. An enclosed chamber surrounding said impeller and mounted on an elevating frame means that is raised and lowered by power means to provide access to service or exchange impellers. Hooklike means automatically attach to elevating frame when it is raised to working position are unhooked by cams to lower frame. Means to insure even lifting and lowering of elevator frame. A hopper is under said chamber with a telescoping extension. Two opposed power means suspended below swingable bases having stabilizers and roller supports; multiple vee belts transfer power means to said cup shaped sheave attached to said spindle; belts tensioned by power means connected in parallel preset to achieve correct belt tension. Lubricating pump powered by a small motor prior to and during startup; power transfers to one of two opposed power means when it reaches full speed. Oil lines to and from bearing to a reservoir. Auxiliary hydraulic power means to raise elevator frame and swing motor bases. A manually swingable boom to change impellers.

### BRIEF DESCRIPTION OF THE SEVERAL VIEWS OF THE DRAWINGS

Page 1 FIG. 1 shows a side vertical view of the invention with viewable parts numbered; both sides are identical.

Page 2 FIG. 2 is a partially sectioned view showing rotating members, drive sheaves, and vee belts, and member 21, an annular chamber, and its elevator frame 7 in working position, and secured by our latching design.

Page 3 FIG. 3 shows member 21 in lowered position to give access to service impeller 60;

FIG. 4 is a plan view of our method to insure even raising and lowering of elevator frame 7.

FIG. 5 depicts one of several different means of customer installations for receiving crushed product and transporting it for additional processing.

Page 4 FIG. 6 is a plan view of the top side having the top hopper removed and sectioned views of the chamber cover 48 to show wedging method 103, drive sheaves on motor shafts and vee belts to driven sheave 50, and a belt drive 108 to power a lube oil pump. Swingable motor bases 85 moved by hydraulics 87 and a swing boom to assist in changing impellers are shown. FIG. 7 details a wedging system.

Page 5 FIG. 8 shows a plan view of said chamber partially sectioned and a simulated propelling of rock; FIG. 9 is a vertically sectioned view of the chamber; FIG. 10 is an enlarged end view of a wedging buttress; FIG. 11 is an enlarged sectioned view of an elastomer seal seated on a steel support; FIG. 12 is a side view of a wedge.

Page 6 FIG. 13 is a plan view of a containment and wear protector ring; FIG. 14 is a vertical exploded and sectioned view of FIG. 13; FIG. 15 is an exploded view of a wedging system; FIG. 16 shows the parts of FIG. 15 fully assembled.

Page 7 FIG. 17 shows a side view of the elevator frame; FIG. 18 is an exploded end view of how its parts assemble.

Page 8 FIG. 19 is a vertical sectioned view of the main rotating parts of our invention; FIG. 20 shows a lube oil injection nozzle.

Page 9 FIG. 21 is a vertical sectioned view of an impeller; FIG. 22 shows the back view, cross-section view, and a sectioned view of a wear tip clamped in working position; FIG. 23 shows the method of retaining the distributor plate.

Page 10 FIG. 24 is a plan view of the top face of an impeller sectioned to show its associated parts; FIG. 25 is a cross-sectioned view a tip holding member.

Page 11 FIG. 26 is a plan and edge view of a combination wear and camming disk; FIG. 27 details a cam slot; FIG. 28 is a sliding means driven by said cam slot.

Page 12 FIG. 29 shows a vertical view of a means to turn a large ring like nut by gear means; FIG. 30 is a plan view of a driving gear within a housing joined to a yoke; FIG. 31 details the connection of the yoke to a spindle.

Page 13 FIG. 32 is a plan view of a swingable motor base; FIG. 33 is a vertical view of said motor base; FIG. 34 shows the pivot means and stabilizers means for said motor base; FIG. 35 shows a roller means supporting said motor base opposite said pivot means.

Page 14 FIG. 36 is a vertically sectioned view showing a means of crushing against impact anvils instead of rock on rock crushing; FIG. 37 is a fragmented plan view of one form of several possible shapes of impact anvils and a means of containment, FIG. 38 is a back view of an impact anvil, and FIG. 39 shows a means of holding anvils against its containing annular wall.

### DETAILED DESCRIPTION OF THE INVENTION

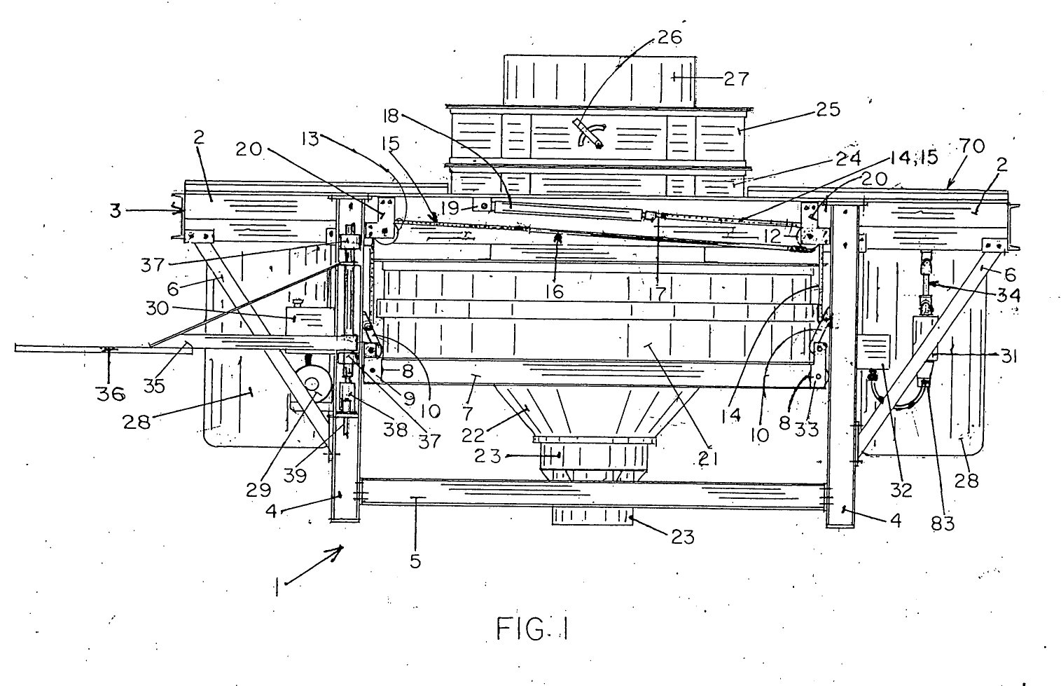

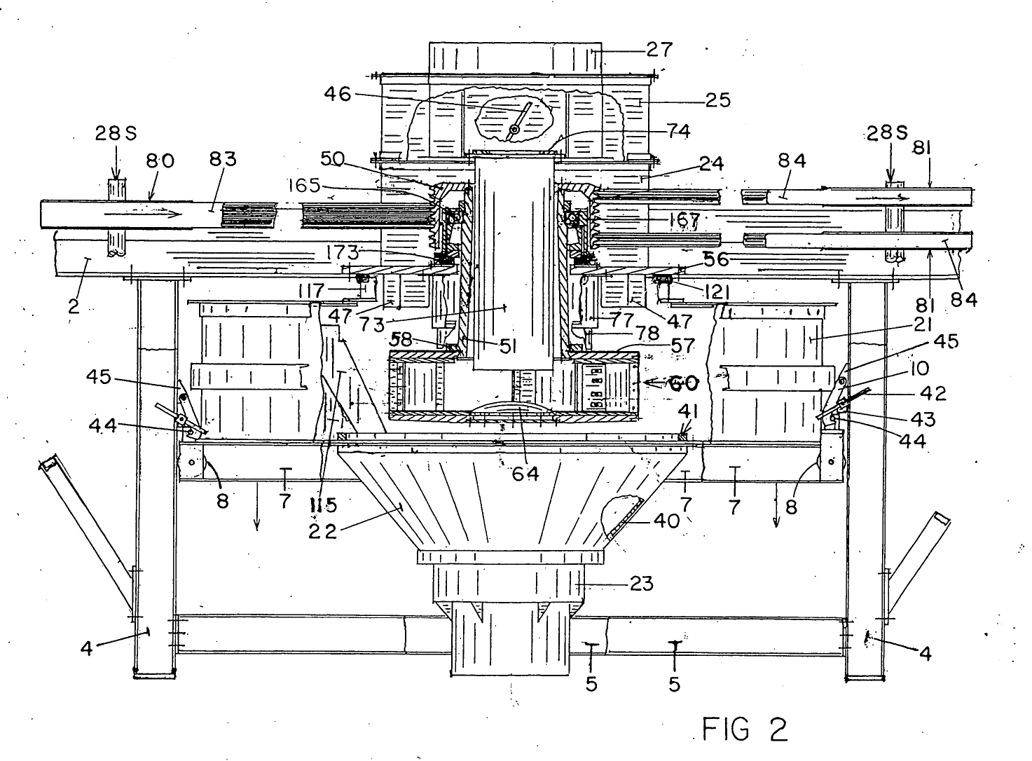

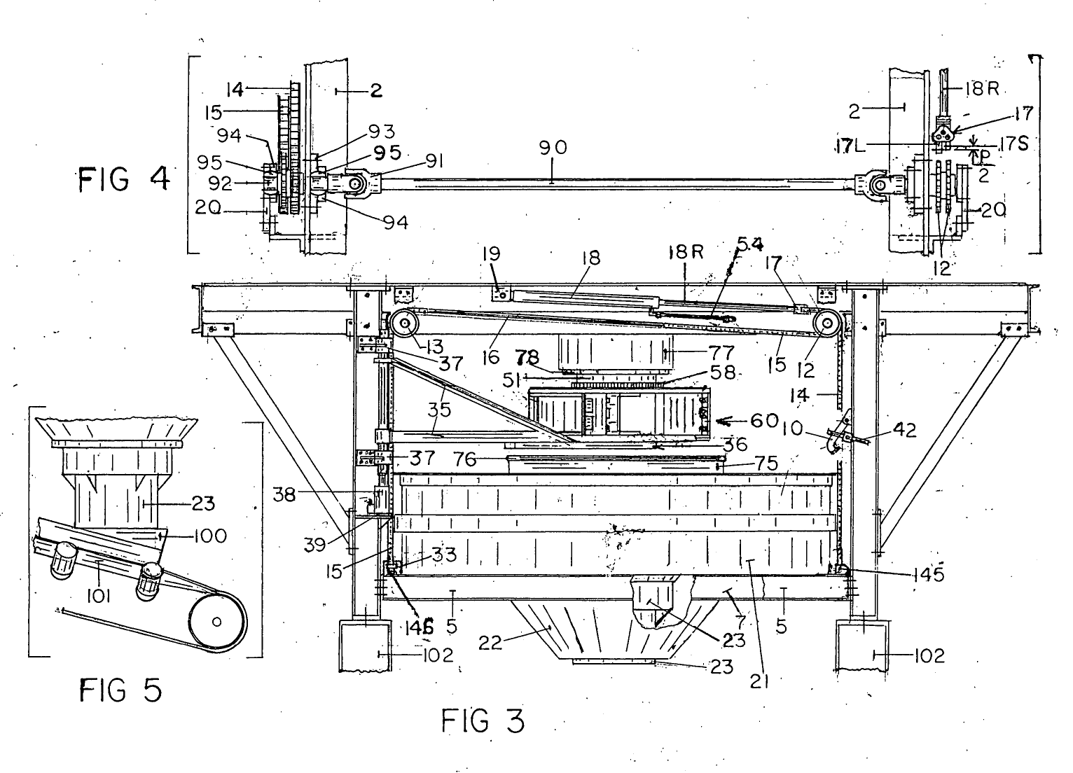

FIG. 1: #1 represents the full side view of a complete machine; its opposite side is virtually identical. #2 is one of two longitudinal main frame beams each composed by having two unequal leg angle irons joined by welds to form a stepped 90° Z; cross beams 3 are at each end of beams 2 and space said beams 2 apart a designed distance; not shown are X bracing of vertical columns 4 90° to beams 2; horizontal beams 5 space columns 4 to parallelism and with angle braces 6 provide a very stiff structure; 7 is one of two parallel beams joined at their ends by channel beams 130 that forms a frame we call an “Elevator”, see Page 7. When the elevator is in working position four hooks 10 hold it from dropping; Two sets of roller chains 14 and 15 connect to equalizer means 17 which connects to the cylinder rod of hydraulic cylinder 18 which is anchored at l9; both #14 chains engage the teeth of inner sprocket 12 less than 90° and connect to said elevator at 145; both chains 15 wrap the outer sprockets of 12 180° and connect to rod 16; two second sections of 15 connect to the other end of 16 roll over sprockets 13 and connect to adjustment means in bracket 33; the length of 16 is the distance between sprockets 12 and 13 minus the stroke of 18 minus enough chain links to avoid contacting either sprocket; double sprockets 12 and single sprockets 13, (means 16, 17, 18 and 19 are better explained on Page 3 FIGS. 3 and 4); means 20 are brackets that support sprockets 12 and 13; #21 is an annular chamber open at top and partially open at bottom for crushed product to exit into and through conical chamber 22 and telescoping extension 23. #24 are two risers to support hopper 25 above a belt drive system; both 24s have passage ways to bypass material to be crushed and passage ways for air recirculation; lever 26 controls an air damper vane and is lockable through 90°; #27 is a hopper extension usually supplied by the customer. #28 are drive motors opposed 180°; #29 is a motor pump unit providing hydraulic power as needed; 30 is its oil reservoir. 31 is lube oil motor pump direct connected to pump 83; that prelubricates an antifriction bearing before motors 28 are started; an overruning clutch mounted on pump motor's top shaft extension allows the pump motor to run before motors 28 start; because drive shaft assembly 34 is driven by one motor after that motor is at full speed and powers lube pump through the lube motor's shaft; the overrunning clutch locks-up, and power to the lube motor is shut off; 32 is its oil reservoir, and oil returns to it in a closed circuit; the oil is filtered. A special grade of oil is required because of the high bearing speed imposed. A swinging boom 35 having a cradle 36 is used to exchange an impeller 60, Page 2 FIG. 2; a hydraulic jack 38 lifts and lowers said boom vertically; bracket 39 supports said jack. 70 are light weight covers spanning the width of the main frame shielding all moving parts from inclement weather.

Page 2 FIG. 2 is a fragmented view showing the main rotating parts sectioned through their center of rotation; sheaves 80 and 81 on their respective motor shafts, 28S, are vee belted to driven sheave 50; belt 83 is a multistrand belt centered over ball bearing 165, twin belts 84 each having one half as many strands as 83 straddle 83; this design eliminates any bending or tilting forces on bearing 165 caused by belt tension or motor torque pulling. Detailed construction of this design is on Page 8 FIG. 19. Sheave 50 is attached to hollow spindle 51 with multiple cap screws; spindle 51 is journaled in bearing 165 which in turn is contained in housing,167; base plate 56 supports 167 through a flexible ring 173; an impeller or rotor 60 is attached to said spindle by a quick attach and release gun lock design; a large nut 58 forces and retains a secure coupling of the gun lock; the nut has gear teeth around its circumference to enable one person to tighten the nut to required torque with a device shown on Page 12. Rock or ore to be crushed is conveyed to hopper 27 where it falls onto choke ring 74 and down stationary tube 73 into impeller 60 which has spinning speeds sufficient to break both ejected rock and other rocks that are in suspension previously ejected or that have fallen through bypass chutes 47. Chamber 21 contains a bed of static rock or ore sloping from wear ring 41 upward and outward at whatever angle of repose is taken. Multiple vanes 115 form compartments and support a containment ring detailed on Page 6; An extremely violent activity occurs within the rock chamber as the energy of several hundred horsepower is converted to accelerating a stream of rock or ore to over 250 feet per second; broken rock and dust are swirling in a tornado of abrasive atmosphere. To protect expensive parts we provide low cost protective means: the top surface of impeller 60 is protected by disc 57, and spindle 51 and gear nut 58 are protected by static annular members 77 and 78; member 78 telescopes into 77 when access to nut 58 is necessary to change impellers; the perimeter edges of the impeller are protected by welds of abrasion resistant metal. #64 serves as both an impact and distributor plate and can be of several different shapes of its top surface. 117 is a rectangle of angle iron extending upward above chamber 21 and is bolted to the top flange of 21; a commercial channel rubber 121 snaps over the upstanding edges of 117 and seals against the underside of plate 56. #45 are brackets to which hooks 10 are pinned; 44 are latching pins for hooks; 43 are cams keyed to cross shafts and bear against each hook; tee handles 42 provide manual leverage to turn all cams from one side of the machine; when elevator 7 is to be lowered a slight upward lift is made to release its weight on the hooks; elastomer 121 yields enough to permit releasing said hooks; levers 42 are turned to force cams to push hooks clear of pins 44; this allows the elevator to be lowered by gravity. Hooks are shaped to automatically latch over pins 44 when elevator is raised to working position. 40 are replacible wear liners to protect conical hopper 22.

Page 3 FIG. 3 shows the elevator in down position with chamber 21 resting on beams 5, and 23 telescoped into hopper 22; #18 is one of two identically mounted hydraulic pull cylinders connected in parallel by hydraulic hoses 54 and then to a control valve not shown; 19 is its anchor bracket and 18R its extended cylinder rod; swing boom 35 is positioned for its cradle 36 to receive impeller 60; a jack 38 either hydraulic or mechanical raises or lowers the boom as its pivot shaft slides in bearing brackets 37; geared nut 58 is unscrewed just enough to free the gun lock; jack 38 raises the impeller just enough to allow manual turning of spindle 51 to where the gun lock will allow separation of the impeller from the spindle; the boom with impeller is lowered and swung outward to a position that will allow exchanging for another impeller.

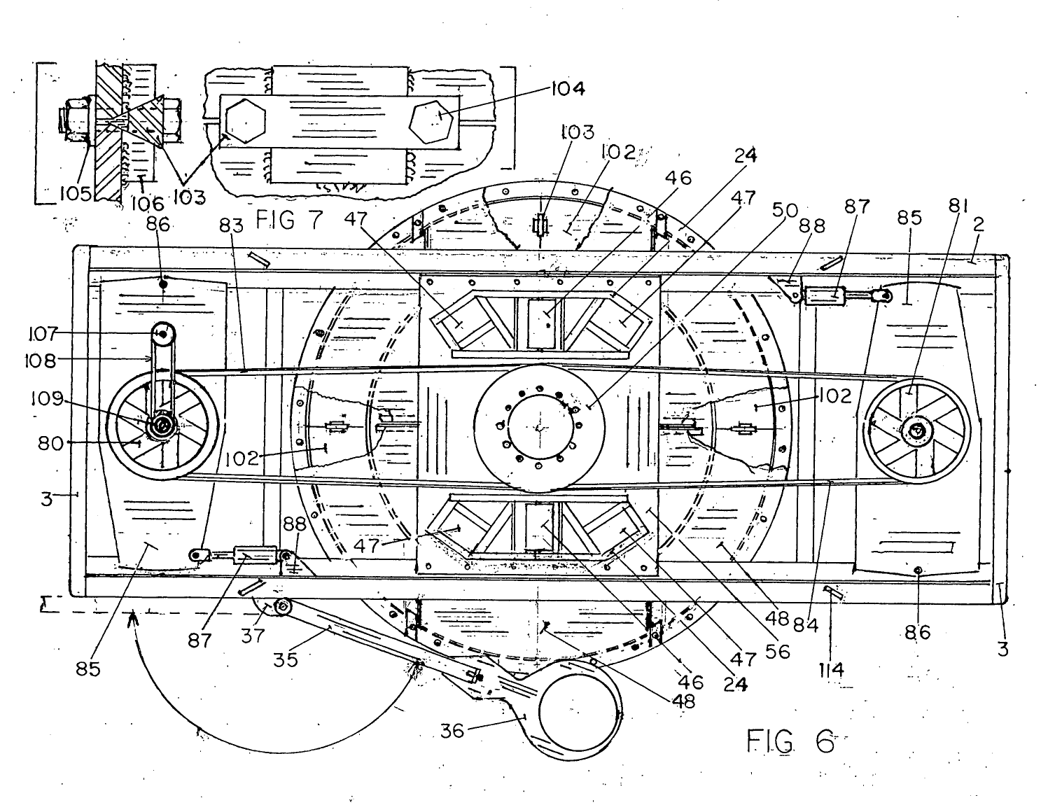

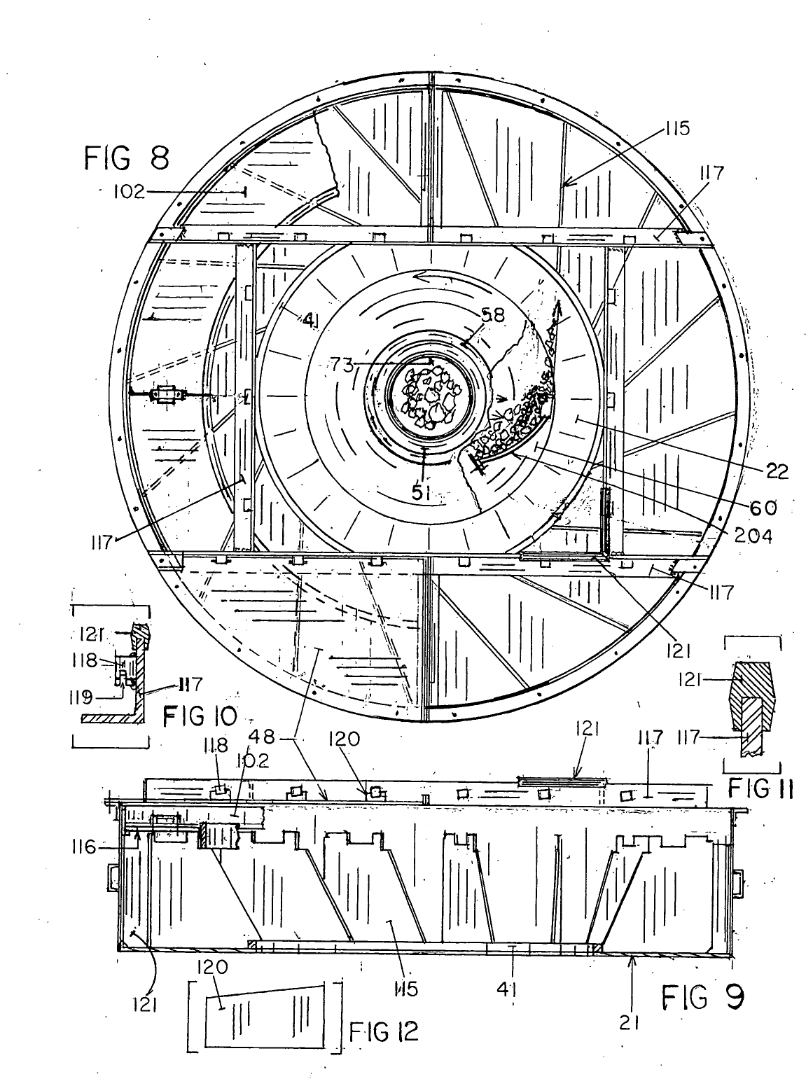

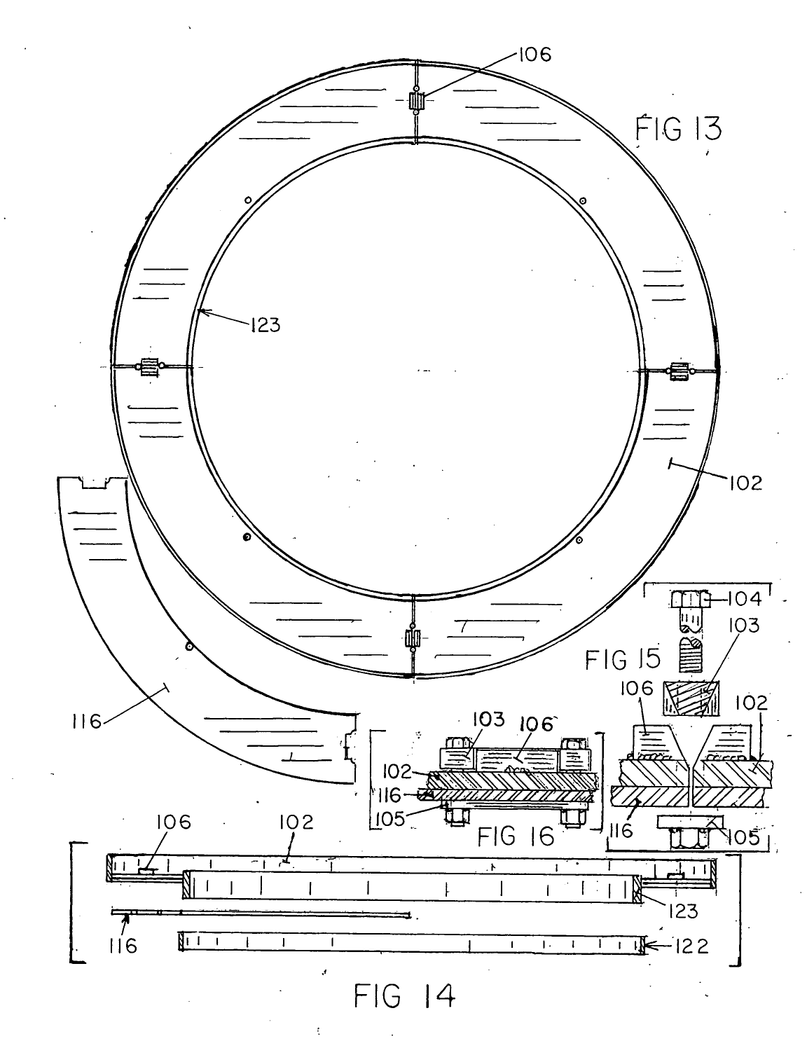

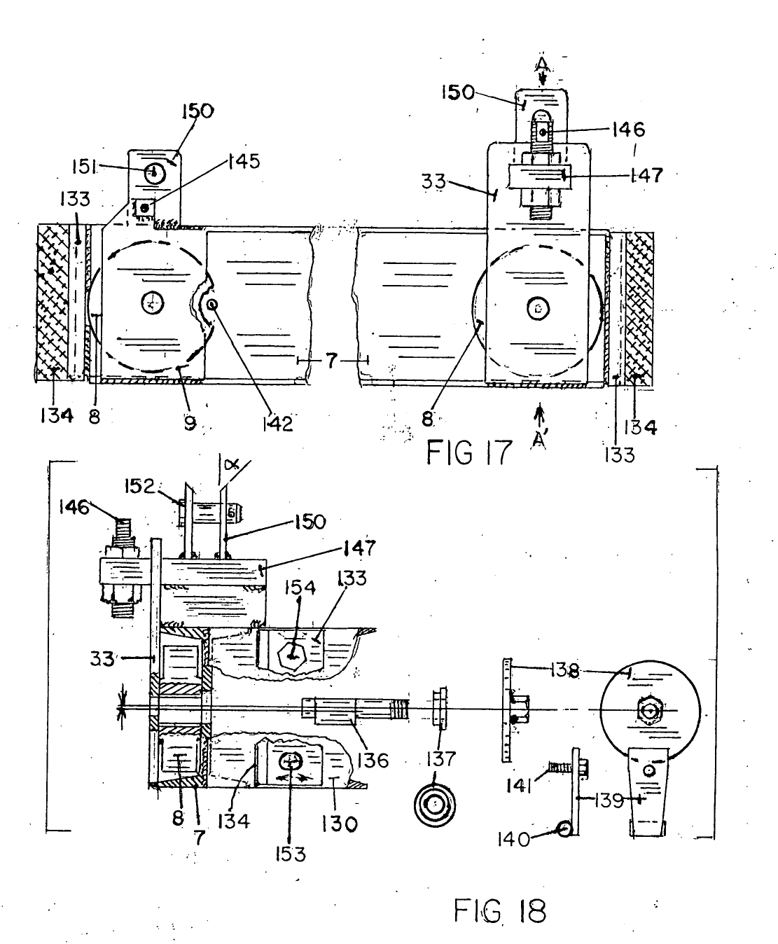

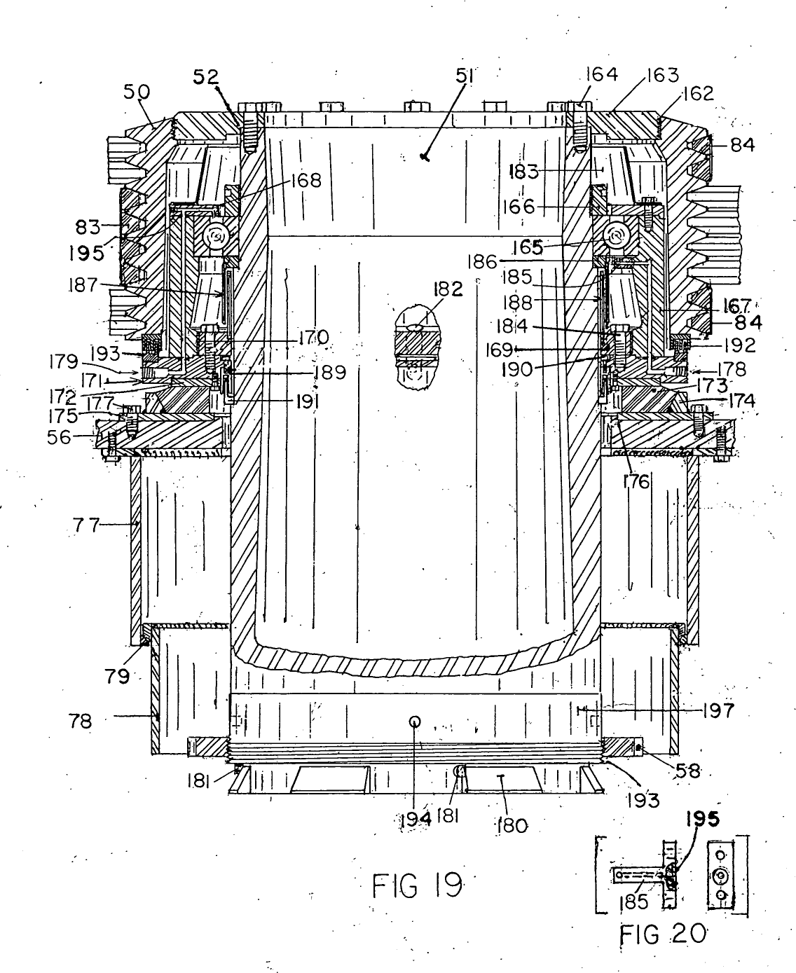

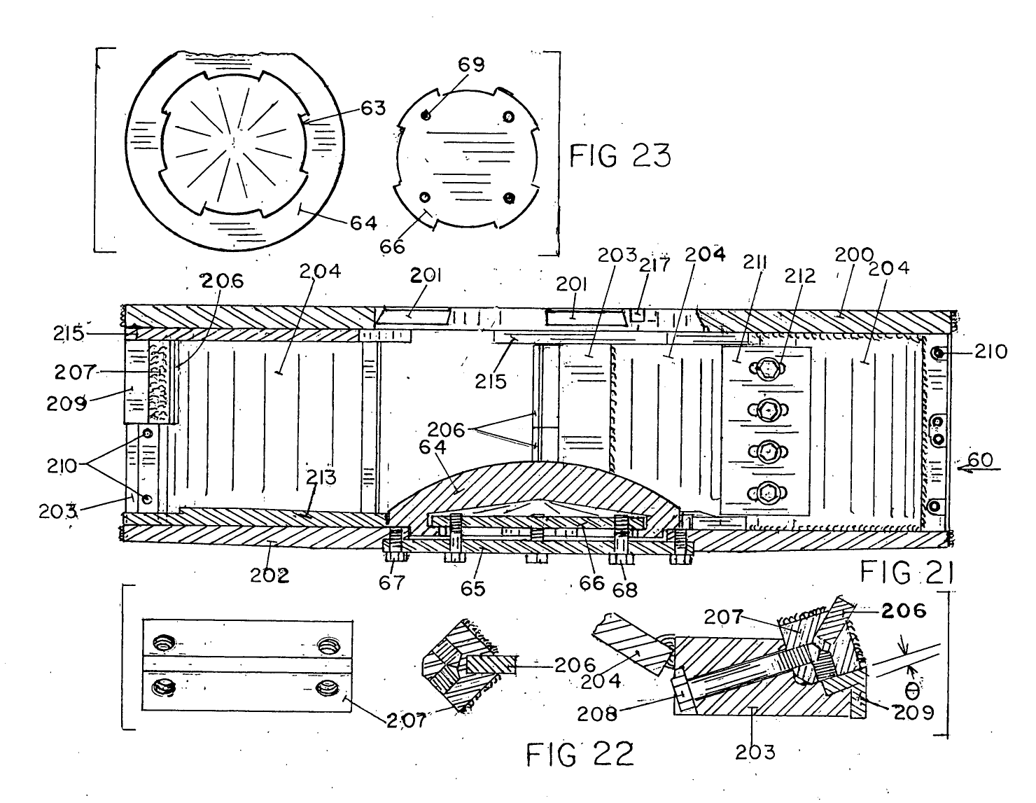

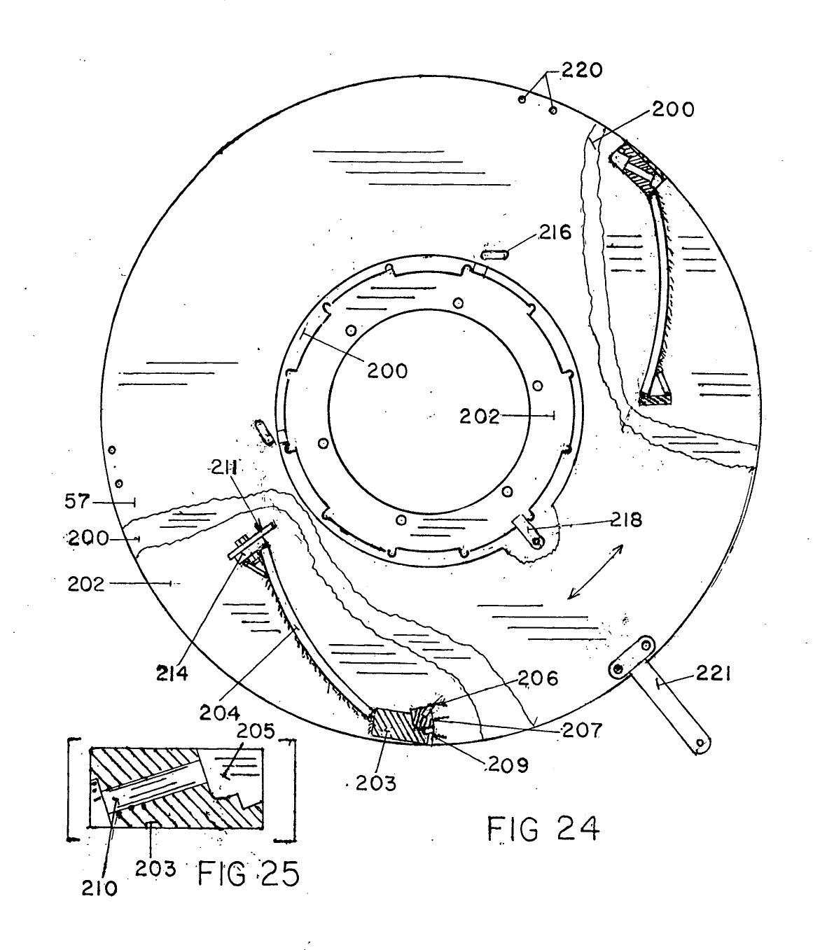

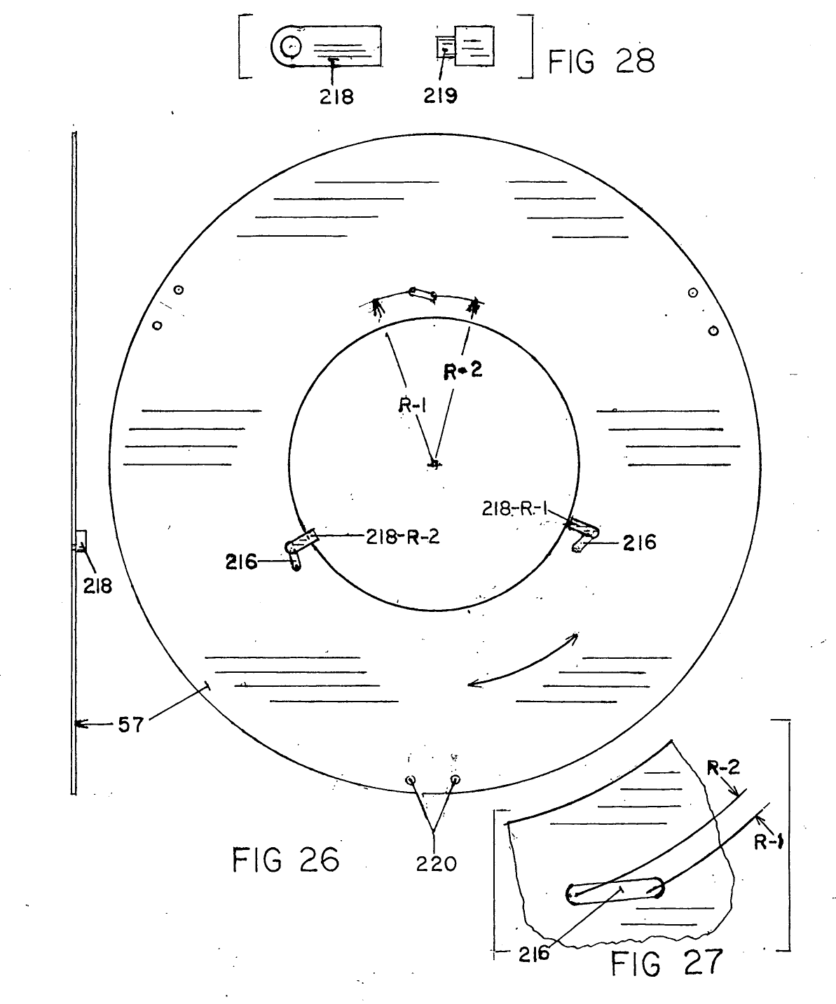

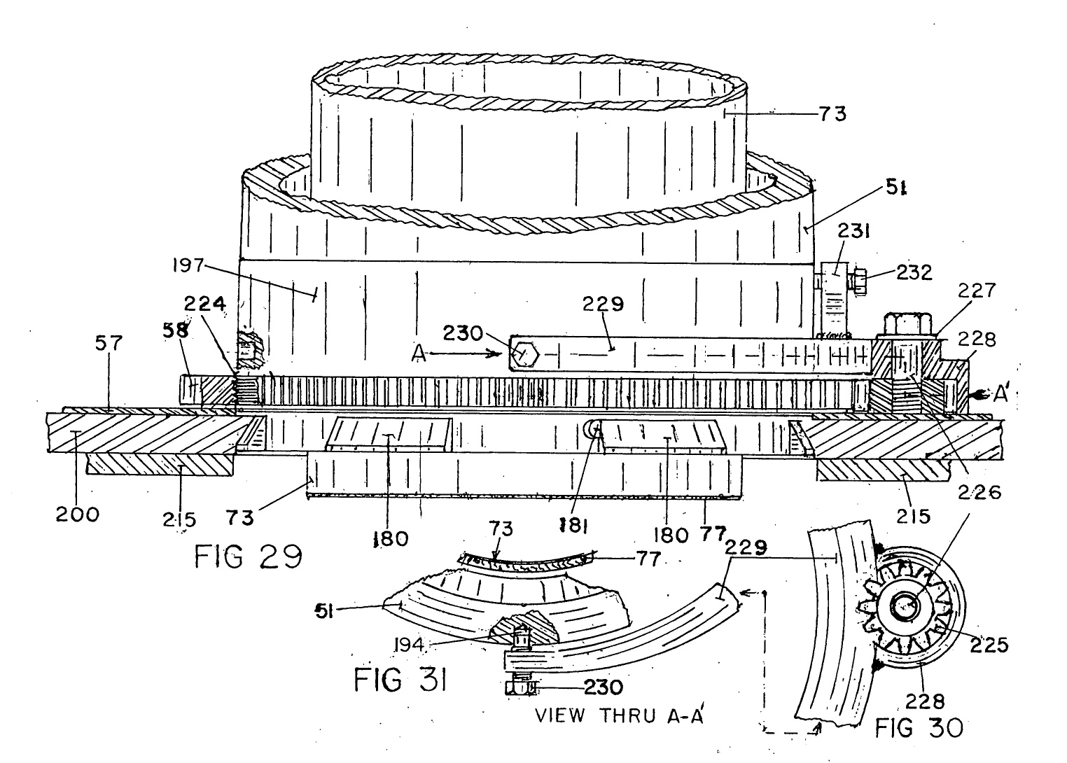

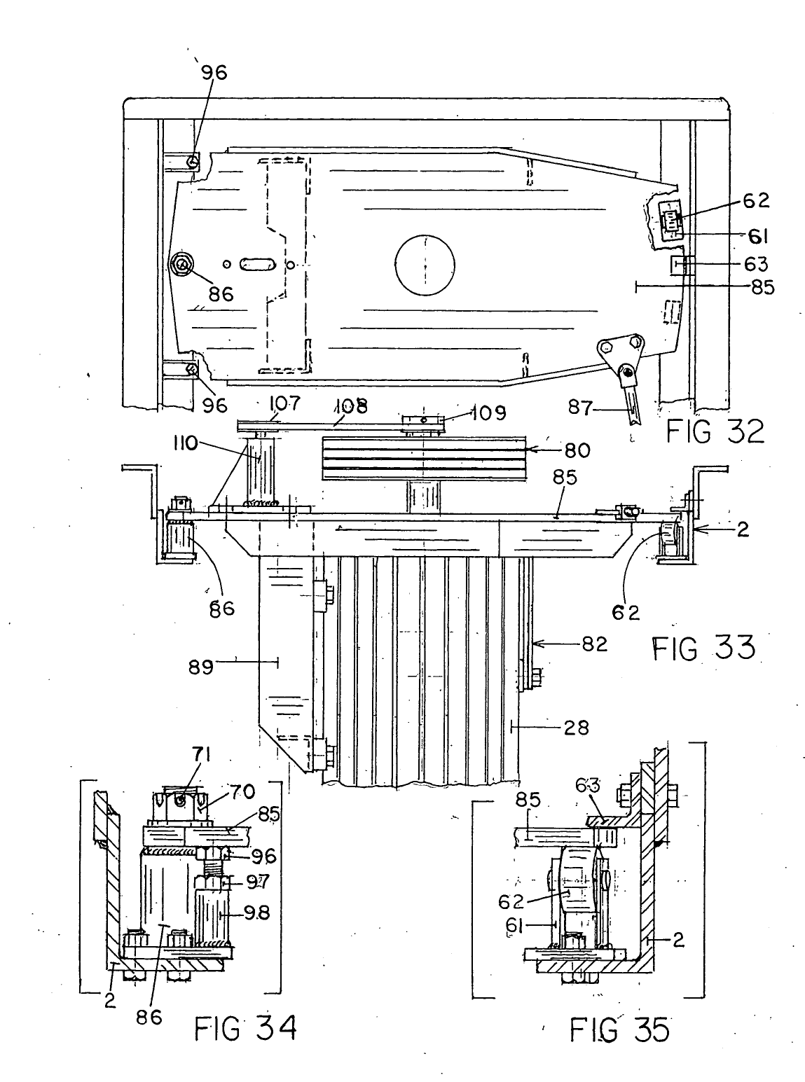

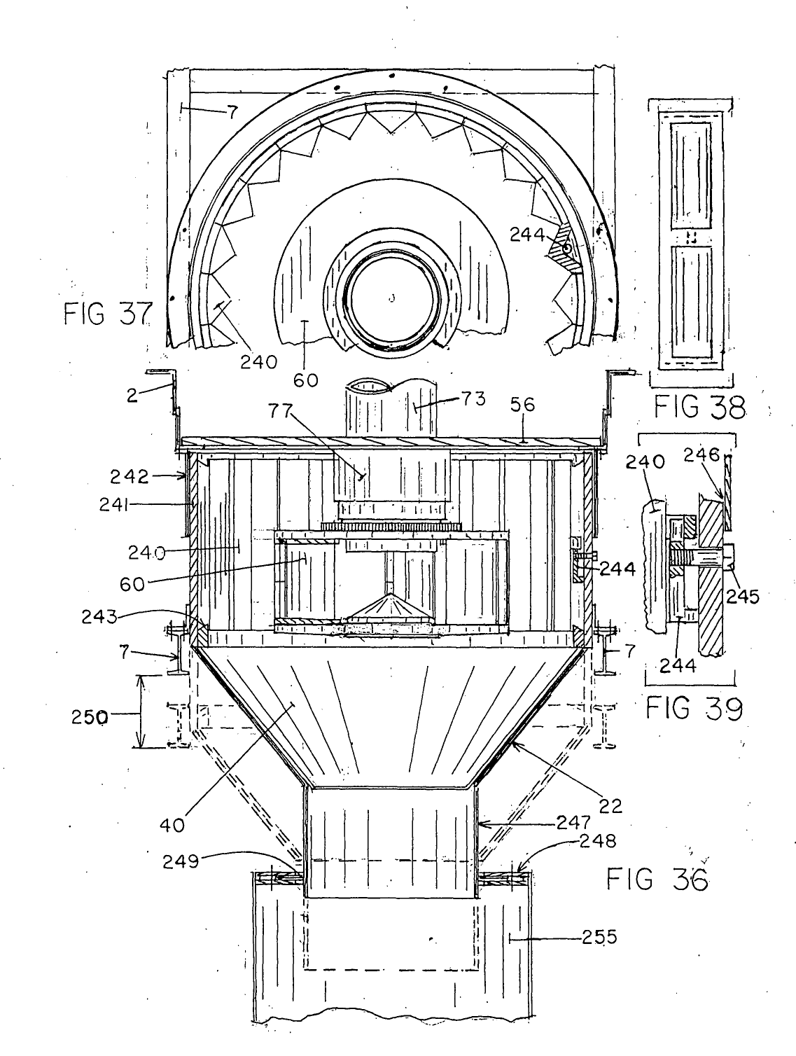

FIG. 4 is a plan view of the means to insure even and controlled lifting and lowering of the elevator; timing shaft 90 has universal joints 91 coupled to short shafts 92 which are journaled in self aligning bearings 95 contained in two piece spherical housings 93 and 94 at inside position and brackets 20 and the same caps 94 at the outside; dual sprockets 12 are keyed to shafts 92 and are staggered one half their tooth pitch as a preferred option, but it is not necessary to stagger; 17 is a means to equalize chain loading. 17L and 17S connect 17 to each chain and their length difference is one half the chain pitch. Chains 14 roll over the inner sprockets then descend directly to brackets 145; chains 15 make a 180° turn around the outer sprockets and connect to rods 16; second sections of chains 15 join to rods 16 and to adjustable anchors 146; rods 16 are used to make chain lengths as short as possible because chains tend to stretch and hang in a sagging curve that affects their lengths adversely, and would making an even lift of the elevator very difficult; the mechanics of both sides are identical. FIG. 5 shows the need for member 23 to telescope into 22, because conveyer 101 an hopper 100 are immovable and to permit the elevator assembly to be lowered we choose this way to accommodate elevator lowering. Vertical shaft crushers generate considerable dust which must be contained; this is best done by air vacuum drawing off dust from a conveyor belt hopper a short distance beyond where 23 joins with the hopper 100 which is enclosed except where the conveyor 101 carries crushed products beyond hopper 100; the dust laden air is cleaned in bag houses.

Page 4 FIG. 6 is a plan view of a complete machine less motors, top hoppers 25 and 27 and covers 70. Main power motors 28 are suspended from steel plates 85, which pivot at 86; and are stabilized and supported level by two supporting roller assemblies opposite to the pivot, and two screw adjusted pads near the edges of plate 85 and slightly offset to pivot 86 (detailed on page 13); push-pull hydraulic cylinders 87 anchored at 88 are connected in parallel with hydraulic hoses and to a control valve which is supplied by pressurized oil from pump means 29 FIG. 1; this system tensions belts 83 and 84 in the push mode to proper tension by an adjustable relief valve and bases can by pulled to release tension at down time to increase belt life and give ample slack to facilitate easy belt replacement. 24 are two supports to raise hopper 25 above sheave 50 to provide top and side clearances for changing belts over sheave 50; when vee belts are changed it is necessary to remove feed tube 73; #47 are bypass chutes to increase crushing efficiency and capacity and to confine overflow within the machine; 46 are damper valves that can be used to control the circulating air that passes through the impeller along with material to be crushed by impact; air volume varies inversely with volume of material passing through ring 74 FIG. 2; recirculating the air reduces its outflow through hopper 23; the tilt of 46 is controlled by exterior lever 26. #102 is an expandable sectioned containment ring that prevents turbulent crushed rock from impinging against the mild steel cover plates 48; sections of 102 are expanded by wedges 103 detailed in FIG. 7; 107 is a pulley mounted on a shaft journaled in a bearing housing (110 FIG. 33 page 13) and coupled to shaft 34 by a universal joint FIG. 1; a vee belt 108 driven by pulley 109 mounted on motor shaft 28S drives pulley 107; said bearing housing is slidable for belt adjustment; when the main motors reach full speed one motor drives the lube oil pump 83 through motor shaft of 31; power to 31 is shut off, this system prevents stoppage of lube oil to bearing 165 by electric power failure. Coasting time of main motors and spindle after power is cut off is several minutes, and this design insures the ball bearing would not be destroyed by lack of lubricant. FIG. 7 shows one of several elongated wedges 103 forced between buttress members 106 by bolts 104 to expand segments of 102 to tightly fit the annular wall of chamber 21; plates 105 partially cover the gaps between sectors of 102 and bolt nuts are tack welded to 105 because the nuts are not vary accessible for a wrench. 114 is one of four lifting attachments.

Page 5 FIG. 8 is a plan view of the rock chamber 21; #115 are multiple vanes set approximately tangent to the rim of the impeller 60; 51 is a section through spindle 51; #58 is the geared nut, and 73 is the stationery down tube through which crushable material drops; a simulation is shown of rock falling through 73 and flowing outward against a static a layer of rock retained by arcuated walls 204; the flowing rock rolls toward and over carbide tips where it leaves the impeller at very fast speeds; as the bed of rock rolls toward the tip it is subjected to several Gs of pressure which causes considerable rock on rock crushing and abrasion before the rock leaves the impeller. Rectangular frame 117 supports the inner edges of cover plates 48 with a wedging system, FIG. 10 buttress blocks 118 having channels 119 to retain wedges 120, FIG. 12, are set to the angle of the wedges and are welded to the upright legs of 117 frame; the wedges press plates 48 firmly against the outer projecting legs of the angle iron members of 117 and can be set and removed quickly; the perimeters of plates 48 are bolted to the top annular angle iron flange of chamber 21; Channel rubber 121 detailed in FIG. 11 is a commercial product and is used to seal the chamber assembly against base plate 56 to prevent the escape of crusher dust. FIG. 9 is a vertical cross sectioned view through the chamber assembly showing containment ring 102 with wear resistant plate 116 resting on the top edges of vanes 115; it also shows wedges 120 in place.

Page 6 FIG. 13 is a plan view of containment ring 102 and one of its wear plates 116; 123 is an inner segmented ring welded to arcuated sectors 102; FIG. 14 is an exploded vertical sectioned view of 102; #122 is a wear ring that fits over the depending portion of 123 and becomes secured in position when 102 is expanded by wedges FIG. 16; #116 have at least one bolt to hold each to 102 until they rest on vanes 115. FIG. 15 is a vertical exploded view of the wedging assembly, and FIG. 16 shows a side on vertical view of a finished assembly. The purpose of this expandable member is protect the top cover from abrasion of flying rock, and its wedge design makes a quick way to install and replace, and a tight fit against the chamber wall holds it securely in place.

Page 7 FIG. 17 is a detailed vertical sectioned view of one side of the elevator frame; the other side is a mirror image. Plate 9 is configured to partially overlap the lower flange of I beam 7 to provide parallelism to the web of the beam, maximum space for rollers 8, and to provide for a strong fillet weld; its top extension provides an anchor attachment 145 for a roller chain connecting link and a partial fillet weld space as below; Plate 33 extends higher than 9 and is slotted to allow adjusting means 146 in horizontal beam 147 to extend the same distance beyond 145 as the space between double chain sprockets 12; threaded member 146 has flats milled to the width of a chain link and a hole drilled to the size of a chain pin; a jam nut above beam 147 and a full thickness nut be low provide for adjusting chains for parallel lifting and full seating of seals 121 against base plate 56. #150 are upstanding members drilled at 151 to receive pins 152 for hooks 10 to latch; angles a are to facilitate engagement of hooks when the elevator is raised to working position. 133 are angle irons with low friction slideway material 134 bonded to their projecting legs. 142 is a threaded hole to receive cap screw 141 FIG. 18. FIG. 18 is an exploded view at right angle to beams 7; # 130 are channel iron crossbeams weld to the ends of I beams 7 to form a rectangular frame; four rollers 8 are journalled on cam axles 136 which pivot in plates 9 and 33 at axles outer ends and within bushings 137 which seat in the I beam's web and allow cams of 136 to be assembled through enlarged holes in beam's web; #137 follow cams and journal cams concentric to bearing holes in members 9 and 33; cam axles are rotated by turning discs 138 with a wrench on the nuts welded to each 138; the nuts are locked to each axle with anaerobic thread locking fluid which bonds strong enough to turn cams but can be broken free to separate parts if needed to repair. Cam axles are rotated to bring rollers to lightly touch uprights 4; third class levers 139 have fulcrum on bars 140 welded to their extreme ends and are clamped to discs 138 by cap screws 141; the cam axles are locked from rotating thereby retaining their adjusted positions. Angles 133 having the low friction slide material bonded to one leg can be adjusted horizontally by elongated slots 153 sliding over and retained by bolts 154; not shown are polished steel guides welded to insides of the flanges of columns 4 for 134 s to slide against; this construction forms a guided elevator frame. This design provides stability to the entire elevator assembly and resists the impacting forces of impinging rock attempting to rotate the rock chamber.

Page 8 FIG. 19 is a vertical sectioned view of the main rotating mechanism. Driven sheave 50 is of two piece fabricated steel construction to attain required strength, low cost of manufacture, and minimum replacement costs; annular rim 50 is rolled steel plate welded at closure of the roll, stress relieved, and fully machined; an internal thread is cut at 162 to a shoulder; plate member 163 is fully machined and threaded into 50 using an anaerobic thread locking fluid to firmly seat against said shoulder; the hand of thread is in the direction that the driving forces will tend to tighten the thread against said shoulder; the cup shaped construction of sheave 50 is to achieve balanced belt pull applied to bearing 165; multiple cap screws 164 join sheave 50 to hollow spindle 51 and is centered to spindle 51 at diameters 52; labyrinth seal 192 is retained to sheave 50 by a slight positive angled taper having an interference fit and is assembled by either expanding the open end of sheave 50 with heat or contracting seal 192 by cooling. #51 is thick walled tube or pipe having an internal diameter large enough to have adequate running clearances around a depending tube 73 and an outer diameter large enough to provide machining to accept a stock size anti-friction bearing such as 165, plus a first shoulder diameter for ring 186 positioned between the bearing and first shoulder; plus a second shoulder for positioning seal 191. Ring 186 has a band 187 secured to it and with 188 which is secured to member 169 ring form a deep labyrinth seal; in addition to first and second shoulders diameters are added larger diameters 197 and thread diameter 198. The bore of 51 is slightly tapered outward above and below the midline of bearing 165 to accommodate any wobbling of the spindle; wobbling can be caused by unbalanced forces within impeller 60. Conical ring 183 has a flange for cap screw attachment to housing 167 and serves as a lube oil retainer; annular nut 166 clamps bearing 165 between it and 186 and enables said bearing to carry the weight of all depending members. Only a ball bearing will cope with the very high speeds required plus thrust loading in both directions, and moment loading caused by an out of balance rotor. In well balanced operations the thrust loading of this bearing is very light, and it has a long life potential; however, the high ball speeds require a special oil that must be applied by spray injection above and below the rolling balls; the oil is conducted by hydraulic hoses, not shown, from pump 83 to inlets 178 and 179; drilled passage ways conduct oil from 178 to nozzle 185 (detailed in FIG. 20) that is retained by cap screws against a flat surface milled in housing 167 an elastomer seal ring 195 prevents oil leakage between nozzle and housing; lube oil sprays upward; an opposed oil passage from 179 conducts oil into bearing clamping ring 168 which is drilled to conduct oil to spray onto balls from above. The flanged conical member 183 diverts oil that may be ejected above the bearing to fall back and through the bearing and to prevent any oil to escape between sheave 50 and housing 167. Housing 167 is either formed from a rolled and welded band or flame cut from a thick plate; it is machined to retain bearing 165, threaded to receive member 169, which is permanently bonded to 167 and has a conical diverging bore for oil drains 182. #171 is an annular plate sufficiently thick to shoulder into 167, have a boss to retain labyrinth seal 193 have oil passages 178 and 179, and receive member 172 recessed into it. The ID of member 171 is configured to retain seal 189 having small cap screws to retain said seal and with space above for clearance for the heads of said screws without interference from 169. #172 is an annular flat ring having an OD to fit into 171 and an ID projecting inward past a flexible member 173 far enough for cap screw attachment to 179 but slightly larger than seal 189; member 174 is a ring fully welded to annular plate 175; its ID is machined to fit bossl76 of base plate member 56; its OD is as flame cut. The inside surface of 174 is machined conical and the top surface of 175 is prepared for bonding as is the under side of 172; these three members are bonded to a low durometer elastomer 173 that is oil and atmosphere resistant; some additional molding parts are used in the molding process to contain the elastomer but are treated to prevent being bonded and are removed after bonding and curing are completed. This mechanism absorbs all but the most severe wobbling and protects companion parts from damage.197 is a cylindrical area with two or more pair of recessed holes 194; each pair of recessed holes are 180° apart; their purpose is explained on page 12 following. 180 are two or more evenly spaced conical sectors with cylindrical sectors between that are slightly longer in arc than the conical sectors and are the male elements of our gunlock connection. 181 are partially threaded studs with one or more tangental flats and are inserted into threaded holes at the trailing end of said conical sectors 180 and with a tangental flat parallel to those ends; trailing end means relative to the rotation of spindle 51. Thread 193 and nut 58 retain impeller 60. #79 is a conical seating means to center telescoping member 78 to static member 77.

Page 9 FIG. 21 is a vertical sectioned view of an impeller also called a rotor; 200 and 202 are crossrolled steel plates for stronger uniform tensile strength across their annular shape to form discs having adequate strength to withstand the very high stresses of centrifugal forces imposed upon them; top disc 200 is thick enough for our gunlock design having inward projecting conical sectors 201 that cooperate with the sectors 180 FIG. 19; the cylinderical arc length between each sector 201 is slightly longer than the arc lengths of 180 so as to allow engagement of the gunlock members; studs 181 prevent the gun lock from disengagement in the trailing direction by engaging 201; the gunlock sectors are tapered so that a tight and firm connection can be achieved when nut 58 is fully tighten, yet release freely when nut is turned open; to prevent the rotor from unlocking in the opposed rotation radial slots 217 are machined into disc 200 their function will be explained later. Our gunlock design is much faster and easier to change impellers than other VSI crushers that use a solid shaft with a top end long taper and a matching taper in a hub attached to the single disk of their impeller which is retained by a thick nut that must be fully removed plus the risk of a stuck taper. Discs 200 and 202 are spaced apart by arcuated members 204 and rectangular members 203 all of which are firmly joined by welds; two or more of sets of 203 and 204 are used usually three or five. The production capacity of a crusher of this type is dependent on the number of said sets, their vertical length, and available horsepower. The openings between members 203 are called “ports.” The abrasion rate within an impeller is huge and must be accomodated with easily installed wear resistant members; the most rapid wear is at the tip 206. Many different concepts of rotors and their impelling means have been tried since VSI crushers first appeared in the 1950s; the average impeller “shoe” as their called, only lasts a few hours as do the static breaker bars that received the impact of propelled rock. The shoes develop valleys and the anvils wear to a cup shape; crushing efficiency diminishes and these two parts rarely use more than 10% of their weight before being replaced. Our new design is detailed in FIG. 22; a carbide insert is retained in a machined slot in a square steel member 207; two faces of which are drilled and threaded; four cap screws are used to hold 207 in a welding and machining fixture; two faces of 207 adjacent to area to be slotted are hardfaced with weld metal while being held in said fixture to restrain 207 from being warped by the welding; the welds stop just short of area to be slotted because the hardface weld metal cannot be machined; the carbide insert is secured in the slot with a high strength anaerobic means. 207 is retained by cap screws 208 through holes 210 in member 203 having a machined seating means 205 FIG. 25 page 10; the rock spill over the tip causes extreme wear conditions as it exits; a wear member 209 protects 203; it is also carbide; it is simultaneously retained with 207 by converging angle θ and its inner vee shape; To achieve maximum tip life tip holder 207 can be turned end for end to use its other set of threaded holes and also be moved vertically to switch positions with its companion because there are two equal length tips in each recess 205; each tip can be used in four different positions; the lower tip gets the most wear. Wear plate member 213 is subject to sliding wear and is best made from high chrome chilled iron, but other metals can be used but will wear faster; upper plate 215 usually lasts a long time and can be flame cut from abrasion resistant steel plate. Member 211 is designed to be positioned radially inward or outward and is clamped in set position by bolts 212; its purpose is to control the depth of rock bed as it lays against members 204 and tip 206 and also to prevent spill over at the trailing edges of 204. Distributor member 64 is cast of abrasion resistant metal and is annular in shape as shown in FIG. 23 a bottom view; inward projecting sectored means 63 are spaced apart to allow outward projecting means of mild steel plate 66 to be assembled into 64 and rotated over 63 to enable cover plate 65 retained with cap screws 67, and cap screws 68 threaded into 66 clamp member 64 in operating position; annular member 64 can be installed through the gunlock opening or through a port in some rotors.

Page 10 FIG. 24 is a partially sectioned plan view of an impeller top protector wear disc 57 made of wear resistant steel plate machinable with carbide tooling; it has three or more camming slots 216 better illustrated on page 11 FIGS. 26 and 27; when an impeller is installed to a spindle member, 57 is rotated with a pin wrench 221 to retract slide bars 218 to maximum outward positions; gear nut 58 has been turned to a light contact with 57; when an impeller is positioned against stops 181; #57 is rotated in the direction that cam slots engaged by pins 219 push slide bars inward; this action captures conical sectors 201 between stops 181 and slide bars 218; the thread of geared nut 58 is of the hand will tighten in the direction that tends to turn 57 to push 218 inward relative to the rotation of the spindle. The functions of other members numbered have previously been explained.

Page 11 FIGS. 26 and 27 show radii R-1 and R-2; FIG. 26 shows slide bar 218 in R-2 and R-1 position; FIG. 28 details slide bar 218 and pin 219 which projects above 218 the thickness of member 57 or slightly less.

Page 12 FIGS. 29,30, 31 show the construction and use of the means of turning gear nut 58: #229 is a 180° yoke slightly larger in inside radius than the radius of cylindrical portion 197 of spindle 51; section 197 has recessed holes 194 that are engaged by screws 230 which have a portion of their threads removed; this locks the spindle relative to small gear 225; screw 232 is positioned against the spindle to restrain the yoke from rising as gear 225 is turned; a wrench having a handle length long enough to apply adequate torque is set on the head of screw 226; #226 is bonded to gear 225 with a very high shear strength anaerobic thread locker; 227 is a flat washer; the outside diameter of teeth of gear 225 is slightly less than the inside diameters of housing 228 so that the reactive force of turning gear 58 is absorbed by the housing rather than by screw 226; the edges of the teeth of 225 are rounded to prevent cutting the bore of 228. Holes 194 must be exactly 180°0 apart to insure proper gear meshing; housing 228 is welded to yoke 229. Prior to this design we used two long spanner wrenches that required two workmen and the wrenches were difficult and awkward to use.

Page 13 FIG. 32 is a plan view of a motor base as used in our VSIC; 85 is a flat plate reinforced by flat bars set edgewise under its longitudinal edges; 85 pivots on member 86 and is stabilized against tipping forces that motor torque applies by means 96 which is detailed in FIG. 34; the opposed end of 85 is arcuated with 86 being the center of the arc; roller means 62 support 85 in a level position and minimize frictional resistance to push-pull swinging of 85 by power means 87. FIG. 33 is a vertical view of 85 including a section of a motor 28 and drive sheave 80. #s 107, 108, and 109 are an auxiliary drive to lubricating oil pump 83 as previously described. 110 is a bearing housing assembly containing two spaced apart antifriction bearings a shaft journalled in said bearing and driven by sheaves 109 and 107 and belt 108; said shaft projects below 85 and is coupled to an overrunning clutch, universal joints, and a slip shaft as shown in FIG. 1 with #34. 89 are depending angle iron members welded to 85 to provided attaching foot mounted motors; their distance from center is determined by the frame size of motors used; means 82 are flat steel bars attached to brackets welded to 85 and a lifting hole that all large motors have; their purpose is to help support the weight of the motor. FIG. 34 shows one of two 98 upright members welded to base plates and bolted to beam #2; each have an internal thread into which cap screw 96 is inserted; the top faces of 96 are polished to remove any stampings; at assembly each are adjusted to light contact against 85, and then jam nuts 97 are tighten; also shown in FIG. 34 is a partially obstructed view of pivot 86; 86 is an upright tubular member with an insert at its top and welded to it; said insert is machined to fit the inside diameter of 86 and the diameter of pivot hole in 85 and threaded to receive castle nut 70 which is adjusted to barely allow free pivoting of 85 and is then locked with a cotter pin 71. FIG. 35 shows one of two roller assemblies 62 journalled in support frame 61 and in contact with 85 to support 85 in a level position; 63 is a bracket set to slight clearance above 85 to prevent a complete assembly of all components of bases 85, motor, and drive from bouncing on the rollers when the machine is being transported.

Page 14 FIG. 36 is a vertical sectioned view of an insertable method of converting our invention from crushing rock on rock to crushing against metal anvils. #241 is an annular steel wall of adequate thickness to support breaker anvils set on a conical member 243; means 244 and cap screws 245 FIG. 39 hold each anvil against said wall; a band 242 with slight clearance 246 encircles 241; assembly sets on the elevator frame; essentially the same impeller is used but might have larger vertical ports; anvils are about twice as long vertically as port depth of the impeller; the elevator is adapted to move down and up slowly and pause at each end of travel; this evens the wear on the anvils and will greatly prolong their useful life, maintain efficient crushing, and minimizing throwaway metal by preventing cupping wear as occurs in the immovable anvils of other vertical shaft impact crushers. To avoid dust escaping a close fitting seal encircles 247 built into hopper 255; a vacuum air pump draws away dust escaping at gap 246. FIG. 37 is a plan view of one of several different designs possible for anvils; FIG. 38 shows the back side of an anvil showing recesses to save weight and casting costs. FIG. 39 details one method of retaining anvils in working position; 244 is a third class lever fulcruming at its lower end against wall 241 and its top end bearing within a hole cast in a central web of anvil 240; cap screw 245 pulls 244 outward.

1 A rock and ore crusher comprising:
(a) a main frame,
(b) an elevator frame insertable within said main frame,
(c) power means to raise and lower said elevator,
(d) an annular chamber on said elevator frame,
(e) an impeller centered within said chamber,
(f) said impeller connected to a vertical hollow spindle with a gunlock coupling,
(g) said hollow spindle journalled in an antifriction bearing,
(h) said antifriction bearing positioned horizontally within an annular housing,
(i) said annular housing attached to an annular plate,
(j) said annular plate has connections and passage ways for lubricating oils and sealing means,
(k) cup shaped sheave attached to top end of said spindle,
(1) flexible means support said annular plate, bearing housing, spindle, impeller, and sheave,
(m) rectangular steel plate means positioned midway in said main frame,
(n) power driven lube oil pump recirculates oil to said antifriction bearing,
(o) dual power means to rotate said spindle with vee belt driving means,
(p) said power means suspended below pivotable frames,
(q) said pivotable frames pivoted by power means,
(r) a static tube centered within said spindle,
(s) said static tube suspended from a top hopper and projecting into said impeller,
(t) bypass means from hopper to chamber
(u) a hopper below said chamber and having a telescoping means within said hopper

2 As in claim 1(a) a rock crusher main frame having two spaced apart longitudinal beams supported on four upright spaced apart parallel columnar beams braced longitudinally and across and having a rectangular steel plate resting midway on inward projecting flanges of said longitudinal beams; pivotal motor bases positioned near each end of said main frame and an elevator frame positioned within said four columnar beams.

3 As in claim 2 a rectangular steel plate supports an annular flexible ring like member which in turn supports an annular plate attached to said flexible member; said annular plate is ported for incoming lube oil fittings, has oil passage ways from fittings to align to vertical oil passage ways in a bearing housing and sealing means, is ported for multiple oil drains; an annular bearing housing is attached to said annular plate; said bearing housing is drilled for oil passage ways and drilled and threaded cap screws; an antifriction bearing is positioned within said bearing housing; pressurized lubricating oil is jetted into said bearing from above and below.

4 As in claim 1(g) hollow spindle is journalled vertically within the antifriction bearing of claim 3; it extends upward a designed distance to position a cup shaped multiple grooved vee sheave to have an equal number of grooves above and below the central plane of an antifriction bearing and be attached to said sheave; said spindle extends downward a designed distance and couples with an impeller; the coupling means is a variation of a gunlock system in which outward diverging conical segments are evenly spaced apart by cylindrical segments having slightly larger arc lengths than said conical segments; means to prevent unintentional disengagement of said gunlock; threaded means to forcibly clamp said gunlock; means to engage and disengage said gunlock; said spindle has slightly diverging internal tapers each side said central plane of said bearing.

5 As in claim 4 an impeller means having a first annular plate means having a concentric opening with intermittent inward converging conical segments spaced between cylinderical segments of slightly larger arcs than said conical segments and having a second annular plate means spaced evenly apart from first annular plate by intermittent wall means joined to rectangular bar means configured to retain replacible wear resistant means; said bar means positioned near the outer perimeters of said annular plate means; said intermittent wall means have designed arc lengths and curve inward stopping a designed radius from centerline of said impeller; flat bar means aligned to said centerline have inner edges joined to ends of wall means; said flat bar means have spaced apart bolt holes; second flat bar means of designed dimensions have elongated openings matching said spaced apart bolt holes to accommodate radial positioning are bolted to first flat bar means; second annular plate means has a concentric opening configured to retain an exchangeable wear resistant means; flat wear resistant means attachable to faces of first and second annular plate means.

6 A ring shaped member having internal threads matching the external threads of said spindle of claim 4 and an outer diameter having gear teeth; an attachable means to said spindle of claim 4 to rotate said ring shaped member.

7 As in claims 4 and 6 a manual means to rotate said gear of claim 6 consisting of a yoke like means attachable to 180° recesses in said spindle; a gear enclosure attached to said yoke at or near 90° of yoke's attachment to spindle means, a small gear joined to a cap screw is journalled in said enclosure; means to prevent gears from separating when torque by a wrench is applied.

8 A disk of wear resistant metal covers the top surface of the impeller of claim 5; said disk has camming means to move a slide means to lock and unlock said gunlock means and to protect said top surface of said impeller from abrasive wear.

9 As in claims 1(b) and 2 a rectangular elevator frame having two longitudinal I beams and two channel cross beams is insertable and removable positioned within said upright columns of said main frame having adjustable positioning means for both roller and sliding means that bear against said columns to restrain said elevator frame from horizontal displacement; raising and lowering elevator evenly by parallel power means connected to roller chain means engaging parallel sprocket means on short shafts journaled in self aligning bearings and joined together by a drive line and universal joints; said elevator held in working position by hooking means; said hooking means disengaged by camming means to permit lowering of said elevator; speed of elevating and lowering elevator controlled by valves.

10 As in claim 1(d) an annular chamber of designed depth seats on the elevator frame of claim 5 and is centered and attached to said frame; said chamber has a ring shaped bottom plate, contains multiple upstanding vanes angled to the radius of said annular chamber, a segmented wear resistant expandable ring resting on said vanes, a segment removable cover supported on a rectangular angle iron means and an outer flange means welded to the annular wall of said chamber; said segmented covers bolted to said outer flange and held by wedges against the flanges of said angle iron means; said angle iron means form a rectangular opening the perimeter of which is capped by an elastomer having channel shape.

11 As in claim 6 a conical hopper means below and in contact with the bottom plate of said chamber and attached to said chamber or to said elevator frame; extending through a bottom opening in said conical hopper a stepped cylinderical member that telescopes upward into said conical hopper.

12 A hopper means above said main frame resting on extension means spaced apart a distance to allow ample clearance to install and remove vee belts driving said multiple grooved vee sheave in claim 4 both across diameter and between the top of said sheave and the bottom of said hopper; said extension means containing bypass chutes; a static tube flanged at its top end suspends through the hopper bottom and through said hollow spindle of claim 4 into said impeller of claim 5; vane like air valves adjusted by exterior means are positioned within recirculating ducts.

13 Motor bases equidistant from said spindle and supported on flanges of said longitudinal beams of said main frame pivot on one beam and rest on rollers on other beam; said motor bases consist of flat plate means depending beam means welded to flat plate means; flat bar means reinforce flat plate means from deflecting forces; adjustable stabilizing means hold plate means against tipping forces; power means joined in parallel push-pull said bases to tension and remove tension of multiple vee belts that transfer motor torque to said cup shaped sheave attached to said spindle in claim 4; means to maintain proper belt tension in push mode.

14 As in claim 1(n) a lubricating system consisting of an oil reservoir, an oil line to a pump said pump connected to a small motor having shafts at both ends; universal joints, a slip shaft, and an overrunning clutch join said small motor to a spindle journalled in a bearing housing attached to the top surface of one of the motor bases of claim 13; a vee belt sheave on said spindle one or more vee belts from said vee sheave to a similar sheave on the shaft of one main power motor; said bearing housing configured to be moveable to obtain belt tension; flexible oil lines from pump to connect to said annular member of claim 3 that is ported to receive said oil lines; drain lines from said annular member to said oil reservoir; small motor powered at startup power disconnects when main motors reach full speed.

15 A swingable boom vertical pivoted in bearing means that accommodate vertical raising and lowering said boom, said boom having a radius from said bearing means to the vertical centerline of an annular cradle at the end of said boom to the centerline of the spindle of claims 1(g) and 4, jacking means to raise and lower said boom, booms on each side of main frame means when specified.

16 In combination a base frame supports a bearing housing attached to an annular member having oil line connecting means, having labyrinth sealing means, and is attached to flexible supporting means; said flexible supporting means attached to a plate means spanning between longitudinal beams; a hollow spindle journalled in an antifriction bearing axially retained in said bearing housing; a cup shaped multiple grooved vee sheave attached to top face of said spindle; labyrinth sealing means between rotating means and companion static means; lubricating means jet oil into said bearing from above and below said bearing; an impeller joined to said spindle at its lower end by an interlocking means of intermittent conical segments; stop means at trailing ends of spindle's conical segments; radial sliding stop means within grooves in annular top member of an impeller; camming means to move said sliding stop means inward and outward; geared rotating means to rotate geared nut means to clamp said impeller firmly to said spindle; a static tube means descends from a top hopper means through said hollow spindle into said impeller a designed distance; an annular chamber of designed depth encloses said impeller; said chamber contains multiple vanes, a segmented wear protector means and supports a segmented top cover means; channel rubber means seal camber against plate means that span across said longitudinal beams; an elevating frame raised parallel timed power means and lowered by gravity supports said annular chamber; self attaching hook means hold elevator at its top position; hooks unlocked by camming means elevator lowers to a resting position of said chamber seating on longitudinal spacing beams of main frame; a conical hopper under said chamber having a telescoping member; a swingable boom having a cradle means is used to position impellers to be connected to said spindle or to remove impellers; said boom is raised and lower by manual jacking means; two opposed power means suspend from pivoting bases an equal distance from said spindle; multiple vee belts transfer motor power to an inverted cup shaped sheave attached to said spindle; power means to tension vee belts an retain tension; power means to retract said bases; means to stabilize said bases on rollers and spaced apart adjustable means; bypass means to transfer material overflow in said top hopper into said chamber and air ducts with volume control vanes to recirculate air pumped by impeller; light weight covers over said main frame each side of said top hopper
